(19) United States
(12) Patent Application Publication
(10) Pub. No.: US 2017/0311109 A1
(43) Pub. Date: Oct. 26, 2017

(54) DISABLE SYSTEM FOR PORTABLE COMPUTING DEVICES

(71) Applicant: Jeri Rodrigs, Ottawa (CA)

(72) Inventor: Jeri Rodrigs, Ottawa (CA)

(21) Appl. No.: 15/134,320

(22) Filed: Apr. 20, 2016

(51) Int. Cl. H04W 4/00; H04W 4/02

(52) U.S. Cl. CPC H04W 4/001; H04W 4/027; H04M 2250/60; H04W 4/023

(57) ABSTRACT

Disable systems for portable computing devices operated by drivers which restrict the ability of a portable computing device to perform certain functions, such as texting, emailing, surfing internet, taking photos by operators and drivers of motor vehicles in motion. The disable mechanism is implemented combining several telematics and electro-magnetic technologies residing in On-board diagnostics (OBD) computer system of an automobile and portable computing device considering various situations an operator of a vehicle can be in. In one embodiment, a portable computing device can provide a disable mechanism with the use of a gigahertz signal in the vehicle by using a motion analyzer, a gigahertz signal receiver, a finger print analyzer and a disable mechanism. In other embodiments, the portable computing device can provide a disable mechanism without modifications or additions to the vehicle with the use of blue tooth signals, signals transmitted by the engine of the vehicle or electronic key, a motion analyzer, a finger print analyzer and a disable mechanism when a driver is engaged with the vehicle.

### CROSS-REFERENCE TO RELATED APPLICATIONS

The present application claims the benefit of provisional application 62/160,942 filed on May 13, 2015, the entire content of which is incorporated herein by reference.

### REFERENCES CITED

### U.S. Patent Documents

| | | |
|---|---|---|
| 5,483,261 | January 1996 | Yasutake |
| 5,488,204 | January 1996 | Mead et al. |
| 5,825,352 | October 1998 | Bisset et al. |
| 5,835,079 | November 1998 | Shieh |
| 5,880,411 | March 1999 | Gillespie et al. |
| 6,188,391 | February 2001 | Seely et al. |
| 6,310,610 | October 2001 | Beaton et al. |
| 6,323,846 | November 2001 | Westerman et al. |
| 6,690,387 | February 2004 | Zimmerman et al. |
| 7,015,894 | March 2006 | Morohoshi |
| 7,184,064 | February 2007 | Zimmerman et al. |
| 7,415,126 | August 2008 | Breed et al. |
| 7,427,024 | September 2008 | Gazdzinski et al. |
| 7,474,264 | January 2009 | Bolduc et al. |
| 7,646,312 | January 2010 | Rosen |
| 7,650,864 | January 2010 | Hassan et al. |
| 7,663,607 | February 2010 | Hotelling et al. |
| 7,898,428 | March 2011 | Dietz et al. |
| 2001/0006886 | July 2001 | Suzuki |
| 2006/0026521 | February 2006 | Hotelling et al. |
| 2006/0097991 | May 2006 | Hotelling et al. |
| 2006/0197753 | September 2006 | Hotelling |
| 2008/0214211 | September 2008 | Lipovski |
| 2009/0082951 | March 2009 | Graessley |
| 2010/0234047 | September 2010 | Lipovski |
| 2010/0323657 | December 2010 | Barnard et al. |
| 8,706,143 | April 2014 | Elias |

### FIELD OF THE INVENTION

This invention relates mainly to facilitate safe operation of portable computing devices, and more precisely, to providing a disable mechanism to prevent drivers from operating portable computing devices while operating vehicles by inhibiting operation of many functions of the device. The same disable mechanism can be used as a safety lock-out feature in case of theft of these computing devices. The disabled portable computing device will have the option to enter into voice activated command mode to activate the disabled functions through hand free setup.

### BACKGROUND OF THE INVENTION

Operating phones while driving has become a major fear of road safety in the last decade with 25% of all vehicle accident is the direct result of use of cell phones while driving—That is 1.3 Million crashes every year. A 2013 study by the National Highway Traffic Safety Administration (NHTSA) indicated that at any given moment during daylight hours, more than 1 million vehicles were being driven by someone using a hand-held cell phone. During that same year, nearly 6,000 people died and a half-million others were injured in car crashes involving a distracted driver, with teens having the highest proportion of distraction-related fatal crashes in US alone.

Using cell phones when driving has become a major concern for parents, law enforcement agencies and to the general public. An April 2013 study found that 80 percent of auto accidents are caused by distractions such as applying makeup, eating, emailing and text messaging on portable computing devices. According to the Liberty Mutual Research Institute for Safety and Students Against Destruction Decisions, teens report that texting and emailing is their number one distraction while driving. Teens understand that texting while driving is dangerous, but this is often not enough motivation to end the practice. Indeed, the enhanced technology and functionality of today's cell phone brings more opportunities for distraction.

New laws are being legislated to make cell phone usage illegal while driving. Many countries and states ban texting while driving and impose heavy fines. However, law enforcement officials report that their ability to catch offenders is limited because the texting device can be used out of sight (e.g., on the driver's lap), thus making texting while driving even more dangerous. Texting while driving has become so widespread it is doubtful that law enforcement will have any significant effect on stopping the practice.

Preventive action is the only fool proof method to reduce number of deaths on the road around the globe by a way of deactivating some features of cell phone operation while driving. Road crashes cost USD $518 billion globally, costing individual countries from 1-2% of their annual GDP. Unless action is taken, distracted driving road traffic injuries are predicted to become the fifth leading cause of death by 2030.

So an opportunity exists in portable computing devices to put into place a disable mechanism to inhibit and disable many functions including the input and, possibly, the reception of text messages while the user is driving. The achievement of such a mechanism may be a significant selling point in the eyes of concerned parents, and it could lead to legislation that would require all portable computing devices to disable texting while driving.

Safety mechanisms for handheld computing device users while driving, as exemplified by those disclosed in U.S. Pat. Nos. 8,706,143; 7,898,428; and 6,502,022 have been developed in the past but none of the inventions disable the portable computing devices unreservedly. For example U.S. Pat. No. 7,898,428 by David gives the control of disablement to the driver. Driver can chose to activate or deactivate the driver safety feature. Studies prove that, if this choice is presented to the driver then they are always willing to take chances and override it which defeats the purpose of the invention. In another example, U.S. Pat. No. 8,706,143 by John uses scenery analysis to determine if the operator of the portable computing devices is in fact the driver of the vehicle. This requires complicated implementation procedure and never can be a failsafe mechanism to determine if the user of the portable computing devices is actually the driver of the vehicle. Other inventions in this area describe about notifying the driver about the received texts, converting the texts to voice and give the driver choice to accept and reply to texts. None of these inventions prevents the operators from using the phones' user interface while driving and help prevent the distracted driving due to operation of the portable computing devices.

Thus, it is apparent that there exists a need for a disable mechanism which unconditionally disables many functions of the portable computing devices when distracted driving conditions are prevalent; very simple to implement; very user friendly; and enable the disabled functions through voice commands. The same disable mechanism without any changes can also be used to automatically deactivate the computing device interfaces in case of theft.

### SUMMARY OF THE INVENTION

Disable mechanisms for driver portable computing devices are disclosed. The disable mechanisms disable the ability of a portable computing device to perform certain functions, such as texting, emailing while one is driving by preventing the device interface capacity to interact with operator.

In one embodiment, a portable computing device can provide a disable mechanism with the help of a low power signal beacon added to a vehicle or in the On-board diagnostics (OBD) computer system. In this embodiment, the portable computing device can comprise a motion analyzer, a signal receiver, finger print analyzer and a disable mechanism. The motion analyzer can detect whether the portable computing device is in motion beyond a predetermined threshold level. The signal receiver can determine whether a holder of portable computing device is located within an un-safe operating area of a vehicle. The finger print analyzer will finally determine if there are multiple passengers in the vehicle. And the lockout mechanism can disable one or more functions of the portable computing device based on output of the motion analyzer and the signal receiver, and enable the one or more functions based on output of the finger print analyzer.

In other embodiments, the portable computing device can provide a disable mechanism with or without modifications or additions to the vehicle. In one embodiment, a vehicle and a portable computing device can provide a disable mechanism in which the vehicle, through detection of a blue tooth signal, can cause many functionality of the portable computing device to be disabled. In another embodiment, a portable computing device can unilaterally provide a disable mechanism by analyzing the finger prints and determine if there is only a driver in the vehicle. In another embodiment, a portable computing device can be enabled by retina eye detector by scanning two set of eyes.

In other embodiments, the portable computing device can provide a lockout mechanism with the finger print analyzer to determine if the operator of the device is actually not the registered owner of the portable computing device for theft prevention.

In all embodiments, the portable computing device can enter into voice activated command mode to enable the disabled functions like texting, emailing to provide normal functioning.

### BRIEF DESCRIPTION OF THE DRAWINGS

FIG. 1 illustrates an exemplary portable computing disable system with portable computing device and vehicle illustrating various components according to one embodiment of the invention.

FIG. 2 illustrates an exemplary vehicle illustrating various components with safe and unsafe operating area according to one embodiment of the invention.

FIG. 3 illustrates an exemplary process in which a vehicle and a portable computing device can provide a disable mechanism according to one embodiment of the invention.

FIG. 4 illustrates an exemplary method in which a vehicle can provide a disable mechanism according to one embodiment of the invention.

FIG. 5 illustrates an exemplary process in which a vehicle can provide a disable mechanism according to one embodiment of the invention.

FIG. 6 illustrates an exemplary method in which a portable computing device can provide a disable mechanism according to an embodiment of the invention.

FIG. 7 illustrates an exemplary process in which a portable computing device can provide a disable mechanism according to an embodiment of the invention.

FIG. 8a illustrates exemplary processes in which a portable computing device can provide normal outgoing functions in disabled mode by voice activated commands which can be implemented in all of the embodiments of the invention.

FIG. 8b illustrates exemplary processes in which a portable computing device can provide normal incoming functions in disabled mode by voice activated commands which can be implemented in all of the embodiments of the invention.

FIG. 9 illustrates various components of a general purpose portable computing device which can implement all of the embodiments of the invention.

FIG. 10 illustrates exemplary portable computing devices that are classified into mobile telephones which can provide a disable mechanism according to all embodiments of the invention.

FIG. 11 illustrates exemplary portable computing devices that are classified into personal digital devices which can provide a disable mechanism according to all embodiments of the invention.

### DETAILED DESCRIPTION OF THE PREFERRED EMBODIMENTS

In the following description of preferred embodiments, reference is made to the accompanying drawings where it is shown by way of illustration specific embodiments in which the invention can be accomplished. It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Embodiments of the invention relate to disabling the ability of a portable computing device to perform certain functions, such as texting, emailing while one is driving. Although some embodiments of this invention may be described and illustrated herein in terms of a disable mechanism to disable text messaging, it should be understood that embodiments of this invention are not so limited, but are generally applicable to disabling any function of a portable computing device that may interfere with the safe operation of a vehicle by a driver, such as prohibiting all cellular telephone operations without a hands-free device, for example. Further, although some embodiments of this invention may be described and illustrated herein in the context of an automobile, it should be understood that embodiments of this invention are not so limited, but are generally applicable to drivers of any vehicle in motion, such as construction vehicle, trucks, trains, boats, ships or airplanes, for example.

Concerns have arisen over the use of portable computing device in moving vehicles. In particular, it has been speculated that drivers using portable computing device might become distracted from vehicle operation and might therefore be more prone to accidents than other drivers who concentrate on driving. One way of addressing these concerns is by disabling the device's certain functions which requires operator's constant input and intervention when the vehicle is in motion. For example, the speed at which a mobile device is moving might be determined by techniques such as using global positioning system (GPS) readings, triangulation, or the number of handoffs of a call between base stations. When the speed of a mobile device is determined to be above a threshold, an assumption can be made that the device is in a moving vehicle.

During the disabled mode, the portable computing device's radio functions including transmitting and/or receiving capabilities will remain in effect to make sure not to lose any telecommunication messages during the disablement, all the voice and data delivery will be done as per the normal task. Only the device's user interface to enter certain inputs and capability of the device to respond to certain inputs might be disabled, or other restrictions might be placed on one or more of the device's functions where operator's attention and input is required for extended period of time. For example, the capability of the device to respond to one or more inputs into the device's keypad might be disabled. This could prevent a user from retrieving or generating text or data messages while the safety disable feature is activated. In general, the device might receive text messages, but the display of incoming text messages on the device might be disabled. In some cases, an audible, visible, tactile, or other indication that a text message has been received might be provided even though the text message itself cannot be seen. On the other hand, the device might receive voice calls and messages, a ring tone or other indicator of an incoming voice call will be provided. Drivers can choose to accept the call if they have hands free blue tooth wireless technology standard for exchanging voice conversation or choose to reject the call. All the transmission and reception activity of the portable computing device is captured and retained in a log file or in a similar data retention location during the disable function is activated in the device for recording purposes and for the operator to verify the data when it is safe to do so.

However, there are situations in which restrictions cannot apply to all portable computing devices in a moving vehicle. For example, if it is determined that the portable computing device of a passenger in an automobile being driven by another person is in motion, the passenger's portable computing device cannot be disabled. Since the passenger is not involved in the operation of the vehicle, the passenger's use of the portable computing devices may not pose a safety risk, and there may be no need to disable the passenger's portable computing device or functions on the device. Similarly, it may be inappropriate to disable the portable computing device of passengers on public transportation vehicles such as buses, trains, boats, ships and airplanes.

In all embodiments, first input component of the portable computing device's disabling algorithm is configured to be based on the speed of the device exceeding a threshold. The disablements remain in effect as long as the mobile device is determined to be in motion above the threshold speed. If the portable computing device's speed drops below the threshold for a short period of time, the disablements might not be lifted and the device might not return to normal operation. This is to avoid the distraction and inconvenience of inputting driver's matrix frequently. The user might become distracted or inconvenienced responding to portable computing device's notification to input driver's matrix each time the mobile device's speed drops the threshold and picks up beyond threshold frequently. In some circumstances, the portable computing device's speed may fluctuate above and below the threshold numerous times in a short period of time. For example, the speed of a mobile device of a user who is driving or riding in heavy traffic on a city street might drop below the threshold each time the user stops at a traffic light and might exceed the threshold each time the user accelerates away from a traffic light. If the mobile device's speed drops below the threshold for a predetermined extended period of time, the disablements might be lifted and the device might return to normal operation. Assumption is made in this case that the vehicle is in traffic congestion or idling for extended period of time and disable functions might be deactivated during this period to facilitate the operator to use the portable computing device in normal operating mode.

In one embodiment, a portable computing device disabling system is provided. The system includes a speed detection component configured to determine the speed at which a portable computing device is moving. The system includes a gigahertz signal beacon or blue tooth device configured to emit signals and gigahertz signal receiver in the portable computing device configured to determine whether the portable computing device is located within the predetermined distance from steering wheel which is considered un-safe operating area of the device inside the vehicle when it is on the move. The system also includes a finger print analyzer to check for multiple passengers in the moving vehicle before disabling the portable computing device. The system will disable one or more functions of the device based on the result of all of above three algorithms. The system also includes a voice command receiver configured to perform the disabled operations through hands free audible voice commands when the portable computing device is in locked-out mode.

In an alternative embodiment, a portable computing device disabling system includes a speed detection component configured to determine the speed at which a portable computing device is moving. The system includes a gigahertz signal beacon or blue tooth device configured to emit signals and gigahertz signal receiver in the portable computing device configured to determine whether the portable computing device is located within the predetermined distance from steering wheel which is considered un-safe operating area of the device inside the vehicle when it is on the move. The system will disable one or more functions of the device based on the result of these two algorithms. The system also includes a voice command receiver configured to perform the disabled operations through hands free audible voice commands when the portable computing device is in locked-out mode.

In another embodiment, a portable computing device disabling system which doesn't require any modification to the vehicle is provided. The system includes a speed detection component configured to determine the speed at which a portable computing device is moving. The system also includes a finger print analyzer to check for multiple passengers in the moving vehicle before disabling the portable computing device. The system will disable one or more functions of the device based on the result of these two algorithms. The system also includes a voice command receiver configured to perform the disabled operations through hands free audible voice commands when the portable computing device is in locked-out mode.

In all embodiments, the user is not given a choice or an opportunity to override the portable computing device's disablement feature since that will undermine the purpose of the invention in preventing distraction of drivers. If the driver is given a choice to activate or deactivate the disabling system then they will be inclined to take chances to deactivate the system to operate the portable computing device while driving. If a driver is responsible enough then they will never operate a portable computing device for the safety of themselves and safety of others around them. One or more functions of the device will be disabled each time the conditions for device's disable system are met.

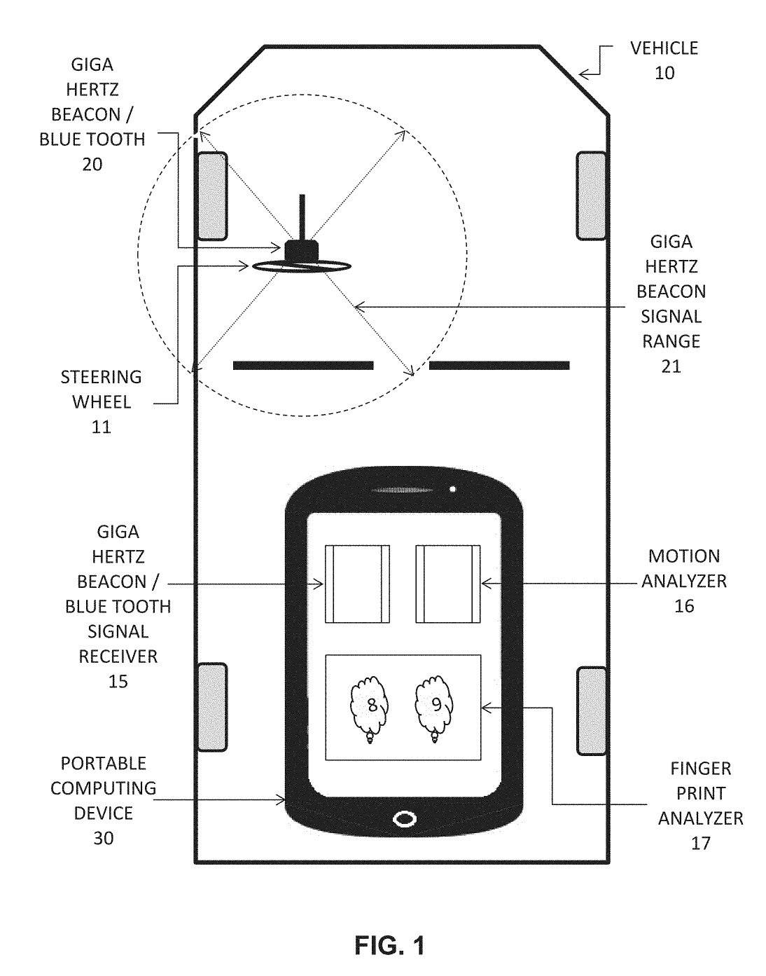

FIG. 1 illustrates vehicle 10 with a portable computing device 30. In the embodiment illustrated in FIG. 1, vehicle 10 depicts a general purpose automobile, portable computing device 30 depicts a general purpose portable computing device which can implement the disable mechanism. Embodiments of the invention are implemented to disable one or more functions of a portable computing device 30 held by a user while the user is operator of the vehicle 10 (e.g., driving the automobile), but enabling the functions of a portable computing device 30 held by a user riding along in vehicle 10 as a passenger. The thick horizontal lines depict the backs of seats in vehicle 10, and the oval portrays a steering wheel 11. A low power and short range gigahertz beacon or blue tooth device 20, as depicted as a black box, is installed on the stem of the steering wheel 11 to transmit gigahertz signals to determine the location of the portable computing device 30 is within gigahertz signal range 21 or not. In this embodiment, the portable computing device 30 is comprised of a gigahertz beacon or blue tooth signal receiver 15 to receive gigahertz signals transmitted by gigahertz beacon or blue tooth device 20, a motion analyzer 16 to detect if motion of the device exceeds a predetermined threshold, and a finger print analyzer 17 to determine the number of people inside the vehicle 10. Finger prints 8 and 9 analyzed by the finger print analyzer 17 will determine if there are more than one personal in the vehicle 10 besides driver.

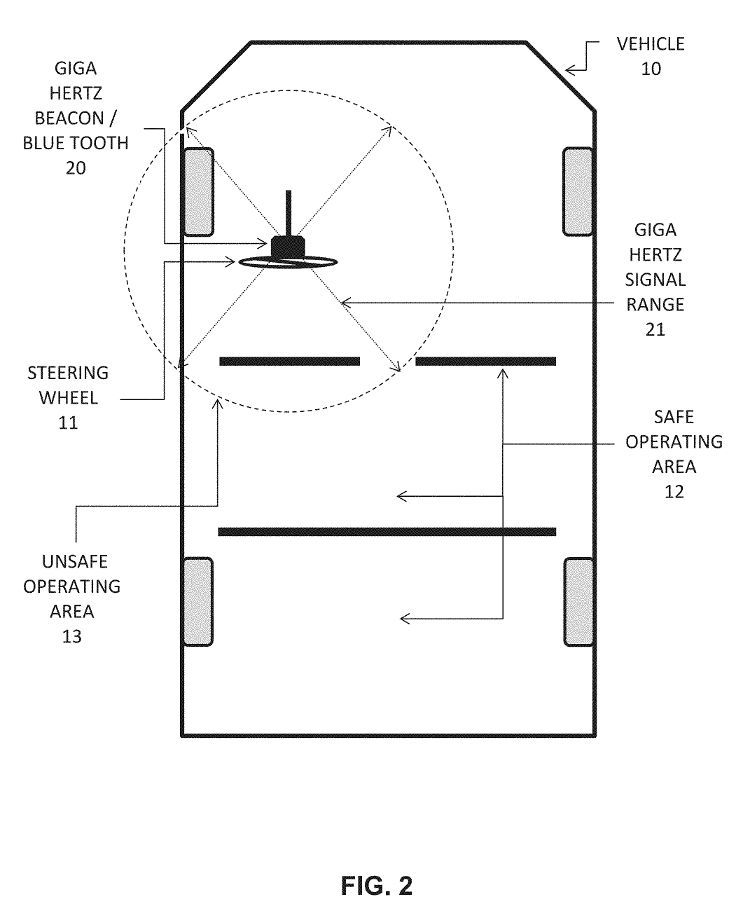

FIG. 2 illustrates vehicle 10 with unsafe operating area 13 and safe operating area 12. Unsafe operating area 13 shows mainly the driver section of the area comprising interior vehicle space designated to the driver of vehicle 10. In this embodiment, the driver section of the area is considered unsafe for operating one or more functions of a portable computing device 30 during operation of vehicle 10. Safe operating area 12 depicts the passenger compartment area comprising interior vehicle space designated to passengers of vehicle 10. The passenger compartment area is considered safe for operating one or more functions of a portable computing device 30 by passengers during operation of vehicle 10 by the driver.

In this embodiment, a gigahertz beacon or blue tooth device 20 is installed to determine whether a holder of portable computing device 30 is located within unsafe operating area 13 of vehicle 10. The gigahertz signal range 21 is configured such a way that the signals transmitted from it will cover all the possible operating positions of a portable computing device 30 held by the operator of the vehicle while driving which is considered to be unsafe operating area 13. The gigahertz signal range 21 is also carefully configured such a way that the signals transmitted from it will not interfere with the safe operating area 12 comprising interior vehicle space devoted to passengers of vehicle 10. Even if the gigahertz signal range 21 overlaps to the safe operating area 12 of the passenger's space, mechanism is in place to allow normal device operation for passengers to unlock the device with the help of finger print analyzer 17.

The motion analyzer can utilize any suitable mechanism to detect whether portable computing device 30 is in motion, such as GPS data and/or cellular telephone signals (e.g., based on changing base station signals and/or signal strength). If portable computing device 30 has an accelerometer, accelerometer motion based on output of the accelerometer can be used to detect whether portable computing device 30 is in motion. If portable computing device 30 has a light sensor, changing light conditions based on output of the light sensor can be used to detect whether portable computing device 30 is in motion.

The unsafe operating area 13 is generally the inside perimeter area of the steering wheel where the operator of a vehicle resides. It should be noted that the designation of unsafe or safe operating area of a vehicle for the purpose of operating one or more functions of a portable computing device 30 may differ according to vehicle type and safety considerations, and is not limited to the designations described and illustrated herein. Likewise, the location of the gigahertz beacon or blue tooth device 20 may also differ according to vehicle type and safety considerations. The gigahertz beacon or blue tooth device 20 also can be a standalone device or can be integrated with the already existing On-board diagnostics (OBD) computer system of any modern automobile.

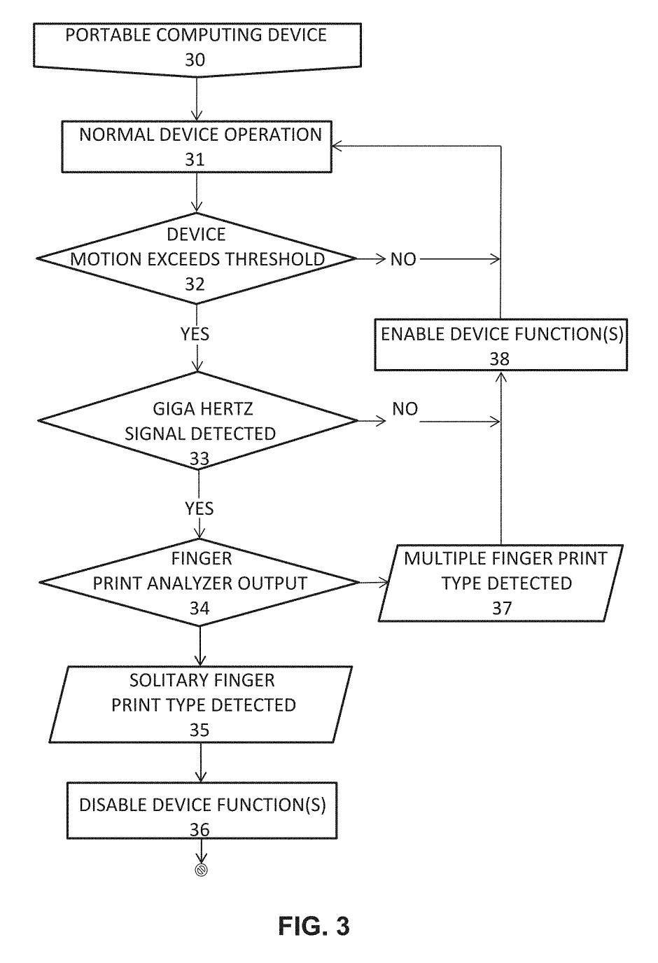

FIG. 3 illustrates a process in which portable computing device 30 can provide a disable mechanism with the help of a gigahertz beacon or blue tooth device 20 added to vehicle 10 as in FIG. 1. In particular, in the embodiment illustrated in FIG. 3, portable computing device 30 can comprise a gigahertz signal receiver 15, a motion analyzer 16, a finger print analyzer 17 and a disable mechanism. The motion analyzer is configured to detect whether portable computing device 30 is in motion beyond a predetermined threshold level (block 32). The gigahertz beacon signal receiver 15 is configured to receive signals transmitted by gigahertz beacon or blue tooth device 20 (block 33) to determine whether a holder of portable computing device 30 is located within the unsafe operating area 13 of vehicle 10. The finger print analyzer 17 is configured to scan finger prints 8 and 9, analyze (block 34) to determine if there are more than one personal in the vehicle 10 besides driver. Assumption is made that there is only one personal in the vehicle if the finger print analyzer 17 detects only solitary finger print type (block 35). The disable mechanism can be configured to disable (block 36) one or more functions of portable computing device 30 based on output of the motion analyzer 16 (block 32), by detecting gigahertz signal (block 33) and the output of the finger print analyzer (block 34).

For example, the disable mechanism can be configured to disable the one or more functions of portable computing device 30 in following steps as explained in FIG. 3. Whenever the output of the motion analyzer 16 of a normal operating device (block 31) indicates that portable computing device 30 is in motion beyond a predetermined threshold level (e.g., speed) (block 32), disable mechanism of the device will continue to check the gigahertz signal receiver 15 to determine if the portable computing device 30 is located within the unsafe operating area 13 in the vehicle 10.

This procedure can prevent portable computing device 30 from being disabled when the user of the device is a passenger in a bus, train, ship or an airplane and if the operator is jogging with the device rather than driving with it. If the output of the gigahertz signal receiver 15 detects gigahertz signal and determines that the portable computing device 30 is located within the unsafe operating area 13 (block 33), disable mechanism of the device will continue to check number of personal in the vehicle 10. This procedure can prevent portable computing device 30 from being disabled when the gigahertz beacon signal range 21 slightly overlaps to the safe operating area 12 of the passenger's space. If the finger print analyzer output (block 34) determines that there is only one operator of the portable computing device 30 in the vehicle 10, assumption is made that the driver is the personal who is operating the device and one or more functions of the portable computing device 30 can be disabled (block 36).

In this embodiment, the disable mechanism is also configured to enable (block 38) one or more functions of portable computing device 30 based on the output of the motion analyzer 16 (block 32), by not detecting the gigahertz signal (block 33) and the output of the finger print analyzer (block 34). For example, the enable mechanism can be configured to enable the one or more functions of portable computing device 30 in following steps as explained in FIG. 3. Whenever the output of the motion analyzer 16 of a normally operating device (block 31) indicates that portable computing device 30 is in motion but has not crossed the predetermined threshold level (e.g., speed) (block 32), the device will continue to be in normal device operation (block 31) mode by enabling the one or more functions of portable computing device 30. Even when the output of the motion analyzer 16 of a normally operating device (block 31) indicates that portable computing device 30 is in motion beyond a predetermined threshold level (e.g., speed) (block 32) but the output of the gigahertz signal receiver 15 doesn't detects gigahertz signal and determines that the portable computing device 30 is located within the safe operating area 12 (block 33), the device will enable one or more functions of portable computing device 30 (block 38) and set the device in normal device operation (block 31) mode. This enables passengers in moving vehicles to operate portable computing device 30 without one or more of its functions being disabled. If the finger print analyzer output (block 34) detects multiple finger print type (block 37) in any of the above circumstances, assumption is made that there are more than one operator of the portable computing device 30 riding in the vehicle 10 besides driver and one or more functions of the portable computing device 30 can be enabled (block 38) to set the device in normal device operation (block 31) mode. This enables passengers in moving vehicles to operate portable computing device 30 without one or more of its functions being disabled.

In one embodiment, the disable mechanism can be configured to enable the one or more functions of portable computing device 30 for a predetermined period of time. In another embodiment, the disable mechanism can be configured to enable the one or more functions of portable computing device 30 for a predetermined number of operations associated with the one or more functions of portable computing device 30 (e.g., the sending or receiving of a predetermined number or text messages).

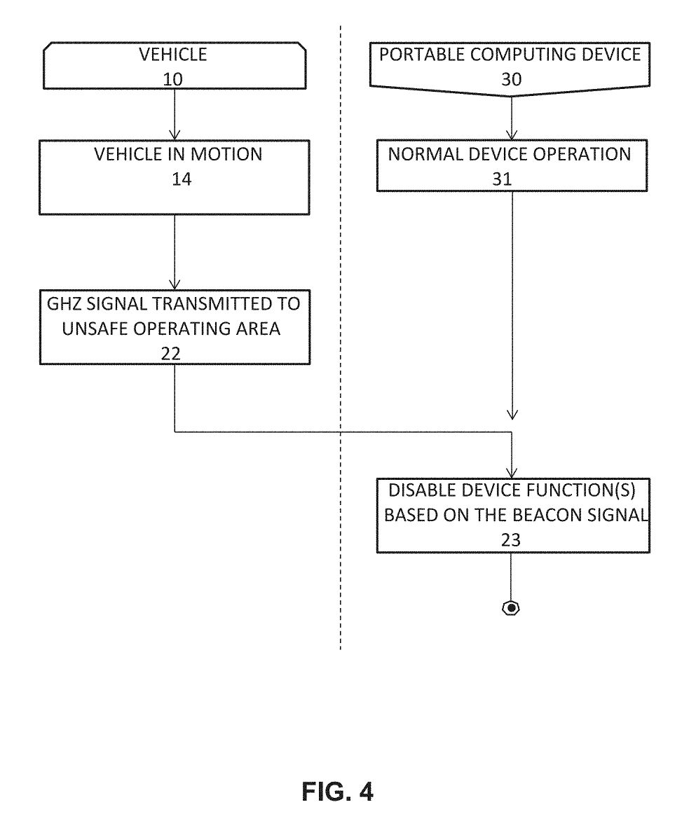

FIG. 4 illustrates a method in which the vehicle 10 (block 10) can provide a disable mechanism with the addition of a gigahertz beacon or blue tooth device 20 the vehicle 10. In this embodiment, a gigahertz signal is transmitted to unsafe operating area (block 22) from the vehicle in motion (block 14). The portable computing device 30 which is in normal operation (block 31) is configured to disable one or more functions based on the beacon signal (block 23).

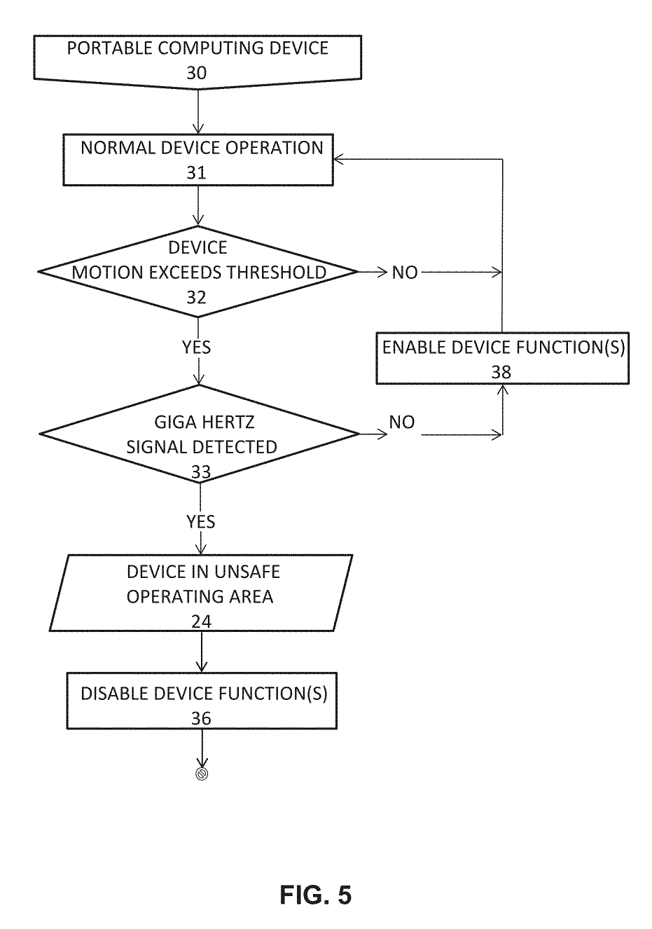

FIG. 5 illustrates the detailed process of the method explained in FIG. 4 in which the vehicle 10 (block 10) can provide a disable mechanism with the help of a motion analyzer 16 and a gigahertz beacon or blue tooth device 20. For example, the disable mechanism can be configured to disable the one or more functions of portable computing device 30 in following steps as explained in FIG. 5. Whenever the output of the motion analyzer 16 of a normal operating device (block 31) indicates that portable computing device 30 is in motion beyond a predetermined threshold level (e.g., speed) (block 32), disable mechanism of the device will continue to check the gigahertz signal receiver 15 to determine if the portable computing device 30 is located within the unsafe operating area 13 in the vehicle 10. This procedure can prevent portable computing device 30 from being disabled when the user of the device is a passenger in a bus, train, ship or an airplane and if the operator is jogging with the device rather than driving with it. If the output of the gigahertz signal receiver 15 detects gigahertz beacon or blue tooth signal (block 33), then assumption is made that device is in unsafe operating area (block 24) and one or more functions of the portable computing device 30 can be disabled (block 36).

In this embodiment, the disable mechanism is also configured to enable (block 38) one or more functions of portable computing device 30 based on the output of the motion analyzer 16 (block 32), and by not sensing the gigahertz signal (block 33). For example, the enable mechanism can be configured to enable the one or more functions of portable computing device 30 in following steps as explained in FIG. 5S. Whenever the output of the motion analyzer 16 of a normally operating device (block 31) indicates that portable computing device 30 is in motion but has not crossed the predetermined threshold level (e.g., speed) (block 32), the device will continue to be in normal device operation (block 31) mode by enabling the one or more functions of portable computing device 30. Even when the output of the motion analyzer 16 of a normally operating device (block 31) indicates that portable computing device 30 is in motion beyond a predetermined threshold level (e.g., speed) (block 32) but the output of the gigahertz signal receiver 15 doesn't detects gigahertz beacon signal (block 33), assumption is made that the portable computing device 30 is located within the safe operating area 12 (block 33), the device will enable one or more functions of portable computing device 30 (block 38) and set the device in normal device operation (block 31) mode. This enables passengers located within the safe operating area 12 in moving vehicles to operate portable computing device 30 without one or more of its functions being disabled.

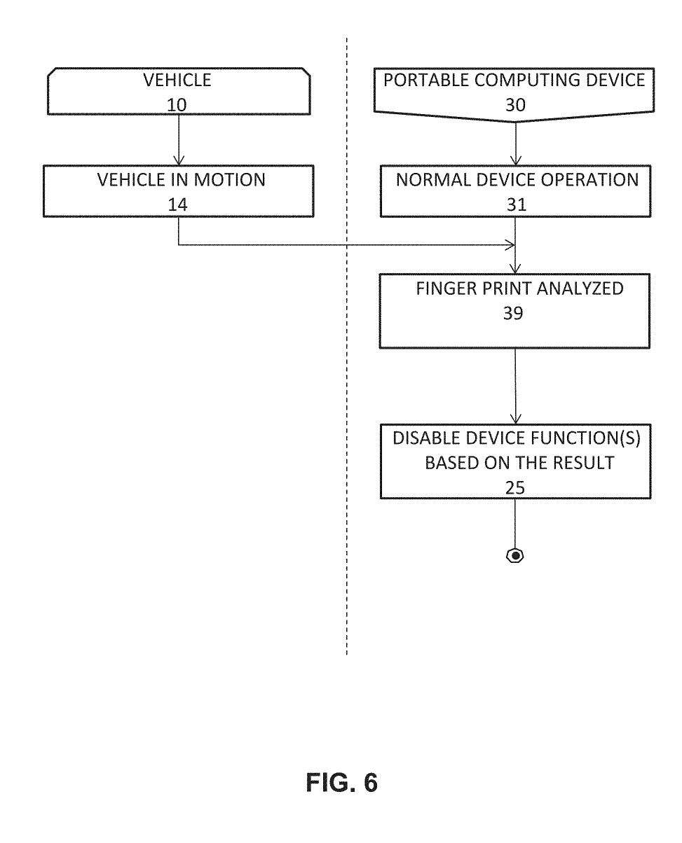

FIG. 6 illustrates a method in which the portable computing device 30 (block 30) can provide a disable mechanism without any addition to the vehicle 10. In this embodiment, output of motion analyzer 16 and finger prints 8 and 9 are analyzed (block 39) to determine if there are more than one personal in the vehicle 10 besides driver. The portable computing device 30 which is in normal operation (block 31) is configured to disable one or more functions based on the finger print analyzer result (block 25).

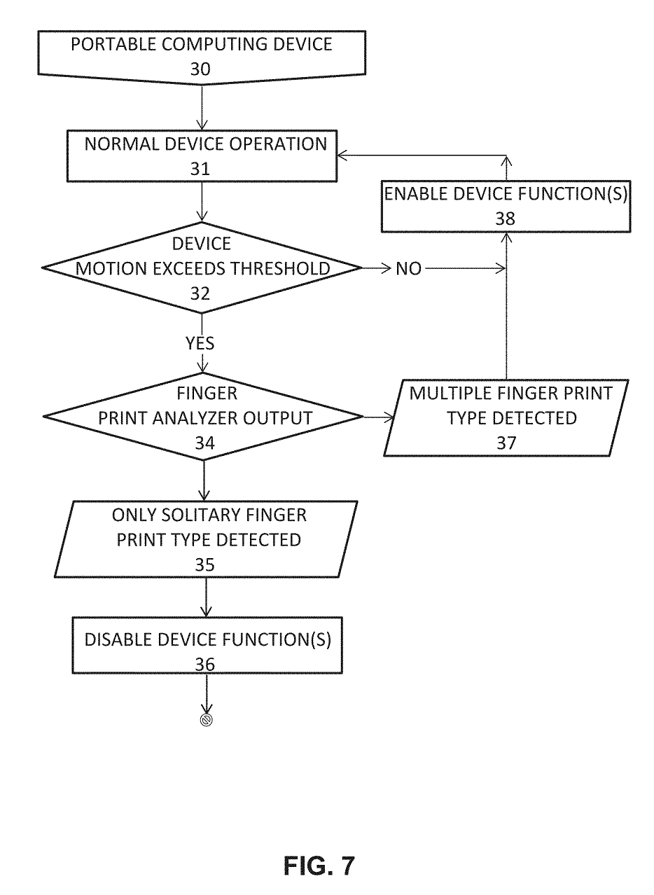

FIG. 7 illustrates the detailed process of the method explained in FIG. 6 where the portable computing device 30 (block 30) can provide a disable mechanism with the help of motion analyzer 16 and a finger print analyzer 17. For example, the disable mechanism can be configured to disable the one or more functions of portable computing device 30 in following steps as explained in FIG. 7. Whenever the output of the motion analyzer 16 of a normal operating device (block 31) indicates that portable computing device 30 is in motion beyond a predetermined threshold level (e.g., speed) (block 32), disable mechanism of the device will continue to check the finger print analyzer 17 to determine if there are more than one personal in the vehicle 10 besides driver. This procedure can prevent portable computing device 30 from being disabled when the user of the device is a passenger in the vehicle 10 with the device rather than driving with it. If the finger print analyzer output (block 34) detects only solitary finger print type (block 35), then assumption is made that there is only one personal is present in the vehicle 10 who is operating the device that is the driver. Portable computing device 30 will then take action to disable one or more functions of the portable computing device 30 (block 36).

In this embodiment, the disable mechanism is also configured to enable (block 38) one or more functions of portable computing device 30 based on the output of the motion analyzer 16 (block 32), and by analyzing finger print analyzer output (block 34). For example, the enable mechanism can be configured to enable the one or more functions of portable computing device in following steps as explained in FIG. 7. Whenever the output of the motion analyzer 16 of a normally operating device (block 31) indicates that portable computing device 30 is in motion but has not crossed the predetermined threshold level (e.g., speed) (block 32), the device will continue to be in normal device operation (block 31) mode by enabling the one or more functions of portable computing device 30. Even when the output of the motion analyzer 16 of a normally operating device (block 31) indicates that portable computing device 30 is in motion beyond a predetermined threshold level (e.g., speed) (block 32) but the finger print analyzer output (block 34) determines that there are multiple finger print type (block 37), assumption is made that there are more than one operator of the portable computing device 30 riding in the vehicle 10 besides driver and one or more functions of the portable computing device 30 can be enabled (block 38) to set the device in normal device operation (block 31) mode for the passengers. This enables passengers in moving vehicles to operate portable computing device 30 without one or more of its functions being disabled.

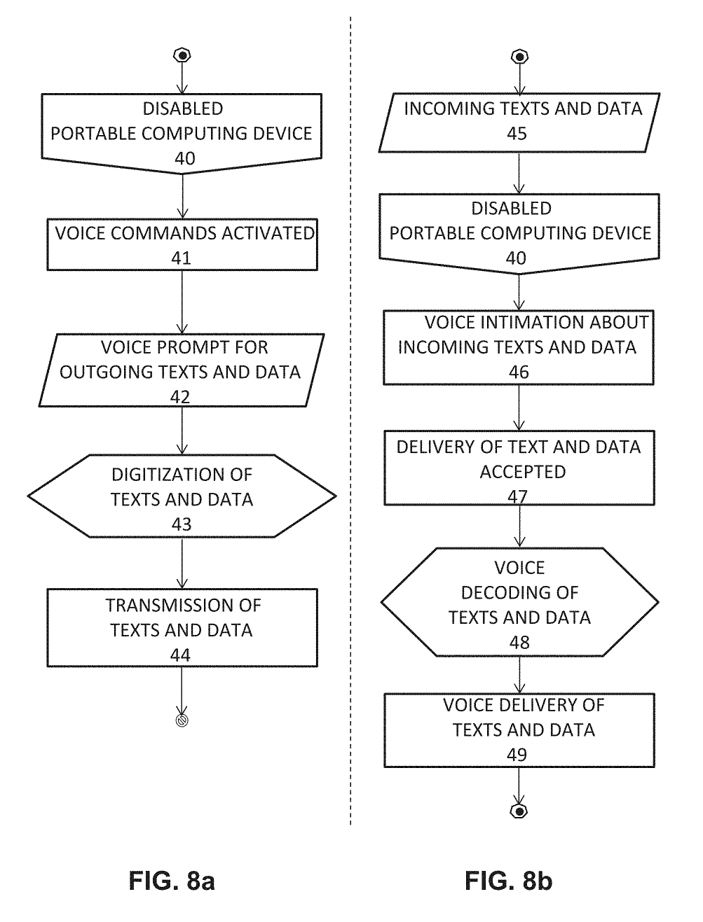

FIGS. 8a-8b illustrates exemplary processes in which a portable computing device can provide normal functions when entered into disabled mode (block 40) by audible voice activated commands, hands free, instead of manually inputting the texts. This feature of the invention will enable the drivers of the vehicle 10 to operate a portable computing device 30 without any distraction. This process can be implemented in all of the embodiments of the invention mentioned in this disclosure.

For example, the portable computing device 30 can be configured to enable one or more functions and send outgoing texts and data when the device is in disabled mode (block 40) without manually inputting the texts using following steps as explained in FIG. 8a. In this embodiment, whenever the device enters into a disabled phase (block 40) the voice commands mode will be activated (block 41) to receive audible voice commands to send outgoing texts and data (block 42). The device is configured to receive destination address and the entire text message through audible voice commands by step-by-step prompts instead of manually inputting the texts through the key board of portable computing device 30. The device will then digitize analog voice texts and data (block 43) in preparation to sending it through transmission network and air. The Voice activated texts and data will be then transmitted (block 44) to its intended destination address. This feature of the invention will enable the drivers of the vehicle 10 to operate a portable computing device 30 and send data (e.g., text) without manually inputting on the key board of the device to avoid any distraction.

In another example, the portable computing device 30 can be configured to enable one or more functions and make delivery of incoming texts and data (block 45) when the device is in disabled mode (block 40) with following steps as explained in FIG. 8b. In this embodiment, if texts and data are received (block 45) whenever the device in a disabled mode (block 40), a voice intimation about the arrival of incoming texts and data (block 46) will be issued to the user. The user now has the choice to accept the delivery of incoming texts and data (block 47) in audio form if they wish to receive texts and data when the device is in disabled mode (block 40). The portable computing device 30 will then decode the received digital texts and data signals into voice prompts (block 48) and make audio delivery (block 49) of them through the device's speakers. This feature of the invention will enable the drivers of the vehicle 10 which operate a portable computing device 30 to receive texts and data (block 45) instantly without manually operating on the key board of the device to avoid any distraction.

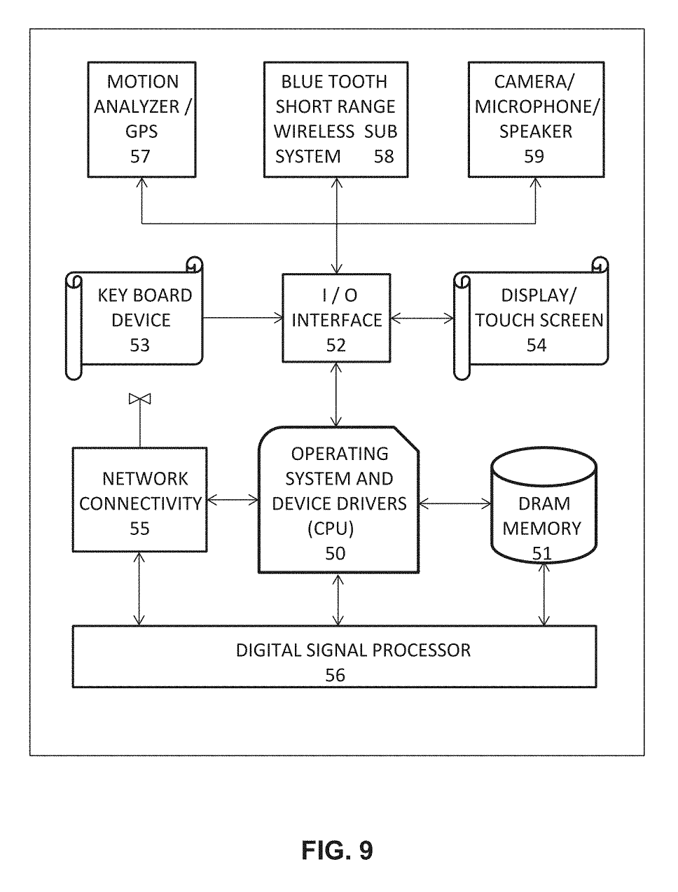

FIG. 9 illustrates exemplary portable computing device 30 that can implement all of the embodiments of the invention described above. Portable computing device 30 includes input and output devices which are connected to central processor unit 50 through input output interface 52. Central processor unit 50 is the core computing element of the portable computing device 30 mentioned in all embodiments of this invention. The operating system which controls all the kernel routines and all the device drivers resides in central processor unit 50. Programs and data required to process the inputs and the outputs are stored in dynamic random access memory 51 of portable computing device 30, which may include solid state memory (RAM, ROM, etc.), hard drive memory, and/or other suitable memory or storage. Transmission and reception of data to and from the network through antenna is coupled by network connectivity 55 and the transported data is processed and executed by digital signal processor 56. The operator interface of the portable computing device 30 is key board device 53 which is used to input the data into the device and display device 54 which displays data (e.g., text, email). The display device/touch screen 54 is also configured to scan finger prints 8 and 9 to analyze and determine if there are more than one personal in the vehicle 10 besides driver. The motion analyzer and GPS 57 is utilized in all embodiments to detect whether the portable computing device 30 is in motion beyond a predetermined threshold level, such as global positioning system data and/or cellular telephone signals (e.g., based on changing base station signals and/or signal strength). Blue tooth short range wireless subsystem 58 in the portable computing device 30 is configured to detect the gigahertz beacon signal transmitted by gigahertz beacon 20 to determine the device is in the unsafe or safe operating area within the vehicle 10. Camera/microphone/speaker system 59 of the portable computing device 30 is to code or decode the voice calls. Camera/microphone/speaker system 59 is also used to input the audible voice commands as explained in the process of FIG. 8a and make audio delivery (block 49) of the texts and data as voice prompts as explained in the process of FIG. 8b.

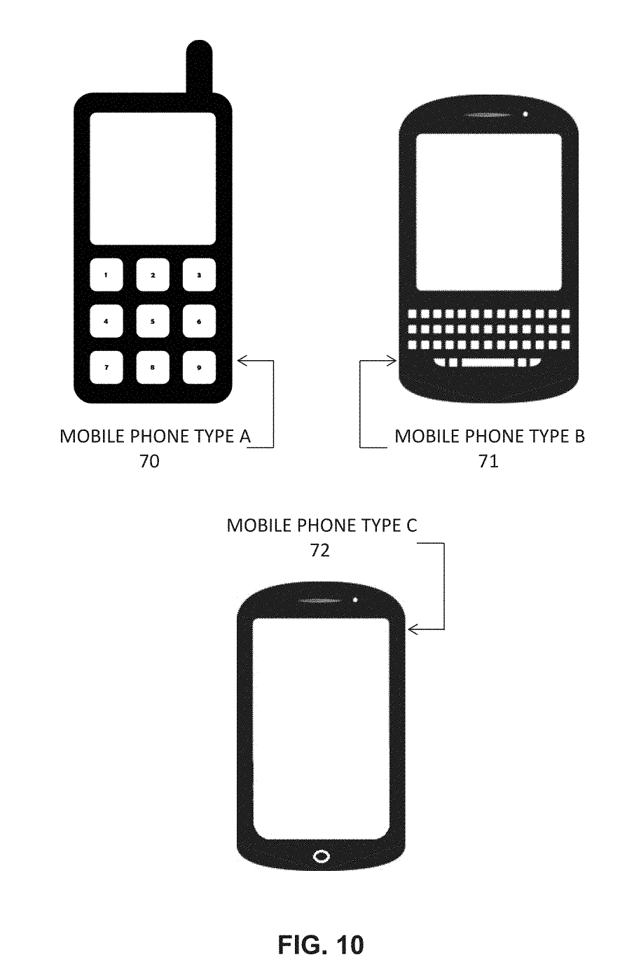

FIG. 10 portraits various types of portable computing device 30 which falls in the category of mobile phones that can implement the disable mechanisms according all of the embodiments illustrated in the above examples. Mobile phone type A 70 is older type of portable computing device 30 which contains all the subsystems as explained in the FIG. 9 that can implement all embodiments of the disable mechanisms. Mobile phone type B 71 is newer type of portable computing device 30 that is classified as smart phone which contains all the subsystems as explained in the FIG. 9 that can implement all embodiments of the disable mechanisms. Mobile phone type C 72 is much newer type of portable computing device 30 that is classified as smart phone which contains all the subsystems as explained in the FIG. 9 that can implement all embodiments of the disable mechanisms.

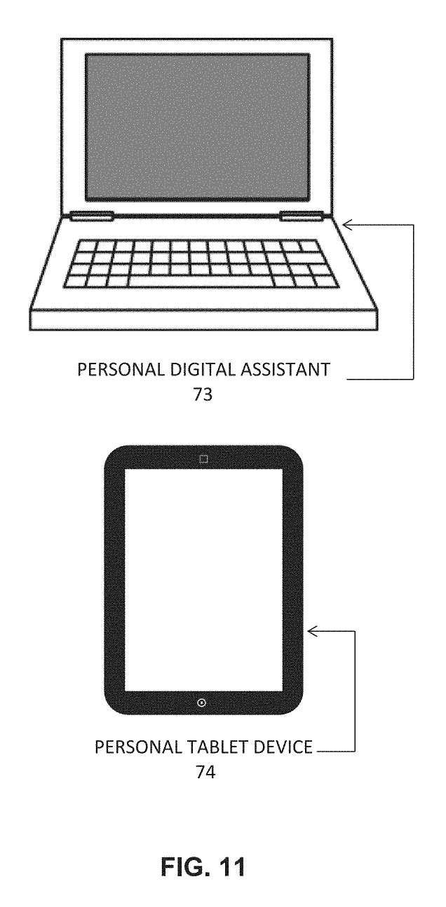

FIG. 11 illustrates exemplary different classes of personal devices that can provide a disable mechanism according to all embodiment of the invention. Personal digital assistant 73 is miniature version of a personal computer which is portable and contains all the subsystems as explained in the FIG. 9 that can implement all embodiments of the disable mechanisms. Personal tablet device 74 is newer version of miniature personal computers which is portable and contains all the subsystems as explained in the FIG. 9 that can implement all embodiments of the disable mechanisms. Additionally, portable computing device 30 may be a combination of these types. For example, in one embodiment portable computing device 30 may be a device that is a combination of Personal digital assistant 73 and a mobile telephone illustrated in FIG. 10. The personal devices of FIG. 11 and mobile telephones of FIG. 10 can prevent the dangerous practice of operating a portable computing device in certain ways while driving by providing a disable mechanism according to all embodiments of the invention.

What is claimed is:

1. A portable computing device comprising:
a motion analyzer configured to detect whether the portable computing device is in motion beyond a predetermined threshold level;
a GPS speed data analyzer configured to detect whether the portable computing device is in motion beyond a predetermined threshold level;
a gigahertz signal beacon configured to transmit signals within the predetermined perimeter from steering wheel of a vehicle;
a gigahertz signal blue tooth device configured to transmit signals within a vehicle;
a gigahertz signal receiver configured to determine whether the portable computing device is located within the predetermined distance from steering wheel of a vehicle;
a finger prints analyzer to determine number of passengers in the vehicle;
a voice command receiver configured to execute one or more functions;
a data transmission system configured to store and send one or more device data to a central data location; and
a disable mechanism configured to automatically and selectively deactivate one or more functions of the portable computing device based on combined analysis of the motion analyzer, gigahertz signal receiver and the finger print analyzer.

2. The portable computing device of claim 1, wherein the disable mechanism is configured to deactivate the one or more functions of the portable computing device when the output of the motion analyzer indicates that the portable computing device is in motion beyond the predetermined threshold level.

3. The portable computing device of claim 1, wherein the disable mechanism is configured to activate the one or more functions of the portable computing device when the output of the motion analyzer indicates that the portable computing device is not in motion beyond the predetermined threshold level.

4. The portable computing device of claim 1, wherein the disable mechanism is configured to deactivate the one or more functions of the portable computing device when the output of the GPS speed data analyzer indicates that the portable computing device is in motion beyond the predetermined threshold level.

5. The portable computing device of claim 1, wherein the disable mechanism is configured to activate the one or more functions of the portable computing device when the output of the GPS speed data analyzer indicates that the portable computing device is not in motion beyond the predetermined threshold level.

6. The portable computing device of claim 2, wherein the disable mechanism is configured to deactivate the one or more functions of the portable computing device after output of the gigahertz beacon signal receiver indicates that the operator of the portable computing device is located inside the predetermined perimeter from steering wheel in the vehicle.

7. The portable computing device of claim 2, wherein the disable mechanism is configured to activate the one or more functions of the portable computing device after output of the gigahertz signal receiver indicates that the operator of the portable computing device is located outside the predetermined perimeter from steering wheel which is safe operating area inside the vehicle.

8. The portable computing device of claim 6, wherein the disable mechanism is configured to activate the one or more functions of the portable computing device after output of the finger print analyzer determines that there is more than one operator of the portable computing device inside the vehicle.

9. The portable computing device of claim 6, wherein the disable mechanism is configured to deactivate the one or more functions of the portable computing device after output of the finger print analyzer determines that there is only one operator of the portable computing device inside the vehicle.

10. The portable computing device of claim 9, wherein the disabled device is configured to execute one or more disabled functions through audible commands while the portable computing device is in disabled mode.

11. The portable computing device of claim 9, wherein the disable mechanism is configured to enable the one or more functions of the portable computing device for a predetermined period of time.

12. The portable computing device of claim 9, wherein the disable mechanism is configured to enable the one or more functions of the portable computing device for a predetermined number of operations associated with the one or more functions of the portable computing device.

13. The portable computing device of claim 9, wherein the disabled device is configured to capture and retain all telecommunication transactions in a log file or in a similar data retention location.

14. The portable computing device of claim 1, wherein the motion analyzer is configured to detect whether the portable computing device is in motion based on Global Positioning System data.

15. The portable computing device of claim 1, wherein the motion analyzer is configured to detect whether the portable computing device is in motion based on cellular telephony signals.

16. The portable computing device of claim 1, wherein the portable device further comprises a speedometer and the motion analyzer is configured to detect whether the portable computing device is in motion based on output of the speedometer.

17. The portable computing device of claim 1, wherein the portable device further comprises a light sensor and the motion analyzer is configured to detect whether the portable computing device is in motion based on output of the light sensor.

18. The portable computing device of claim 1, wherein the disable mechanism is configured to receive the gigahertz beacon signal to determine the portable computing device is located inside the predetermined perimeter from steering wheel inside the vehicle.

19. The portable computing device of claim 1, wherein the disable mechanism is configured to analyze finger prints to determine number of people inside the vehicle.

20. The portable computing device of claim 1, wherein the one or more functions of the portable computing device includes a text messaging function.

21. The portable computing device of claim 1, wherein the one or more functions of the portable computing device includes an email messaging function.

22. The portable computing device of claim 1, wherein the disable mechanism is configured to deactivate one or more functions of the portable computing device after output of the finger print analyzer determines that the finger print analyzed does not match to the one registered by the owner of the portable computing device.

23. The portable computing device of claim 1, wherein the vehicle ignition mechanism is configured to turn off if the gigahertz beacon is un-plugged and deactivated by the operator of the vehicle.

24. The portable computing device of claim 1, wherein the voice command receiver is configured to accept and execute commands inside portable computing device.

25. The portable computing device of claim 1, wherein the disable mechanism is configured to store all the telecommunication activities of the device in a log file.

26. The portable computing device of claim 1, wherein the disable mechanism is configured to store and send one or more device data to a central data location.

27. The portable computing device of claim 1, wherein the disable mechanism consists of a gigahertz beacon configured to transmit gigahertz signal to unsafe operating area of the vehicle.

28. A process comprising:
detection using a motion analyzer or GPS speed analyzer whether the portable computing device is in motion beyond a predetermined threshold level;
determining using the gigahertz signal receiver whether the portable computing device is located within a predetermined perimeter from steering wheel of a vehicle based on the presence of gigahertz beacon signal data;
determining using the finger print analyzer if multiple passengers present in the vehicle; and
automatically and selectively deactivating one or more functions of the portable computing device when the portable computing device is detected to be in motion beyond the predetermined threshold level; the portable computing device is determined to be located within the predetermined perimeter from steering wheel area of the vehicle; and
determined multiple passengers are not present in the vehicle.

29. The process of claim 28, wherein the one or more functions are configured to be enabled for a predetermined period of time.

30. The process of claim 28, wherein the one or more functions are configured to be enabled for a predetermined number of operations associated with the one or more functions of the portable computing device.

31. The process of claim 28, wherein the one or more functions of the portable computing device includes a text messaging function.

32. A portable computing device system comprising:
a motion analyzer configured to detect whether the portable computing device is in motion beyond a predetermined threshold level;
a GPS speed data analyzer configured to detect whether the portable computing device is in motion beyond a predetermined threshold level;
a gigahertz beacon signal receiver configured to determine whether the portable computing device is located within the predetermined perimeter from steering wheel of a vehicle;
a gigahertz signal blue tooth device configured to transmit signals within a vehicle;
a finger prints analyzer to determine if there are multiple passengers in the vehicle;
a voice command receiver configured to execute one or more functions; A data transmission system configured to store and send one or more device data to a central data location; and
a disable mechanism configured to automatically and selectively deactivate one or more functions of the portable computing device based on combined analysis of the motion analyzer, signal receiver and the finger print analyzer.

33. A mobile telephone comprising:
a motion analyzer configured to detect whether the portable computing device is in motion beyond a predetermined threshold level;
a GPS speed data analyzer configured to detect whether the portable computing device is in motion beyond a predetermined threshold level;
a gigahertz beacon signal receiver configured to determine whether the portable computing device is located within the predetermined perimeter from steering wheel of a vehicle;
a gigahertz signal blue tooth device configured to transmit signals within a vehicle;
a finger prints analyzer to determine if there are multiple passengers in the vehicle;
a voice command receiver configured to execute one or more functions;
a data transmission system configured to store and send one or more device data to a central data location; and
a disable mechanism configured to automatically and selectively deactivate one or more functions of the portable computing device based on combined analysis of the motion analyzer, signal receiver and the finger print analyzer.
